(19) United States
(12) Patent Application Publication
(10) Pub. No.: US 2018/0295357 A1
(43) Pub. Date: Oct. 11, 2018

(54) DISPLAY SYSTEM OF WORKING MACHINE AND DISPLAY METHOD OF WORKING MACHINE

(71) Applicant: Komatsu Ltd., Tokyo (JP)

(72) Inventors: Yosuke Okumura, Hiratsuka-shi (JP); Takehiro Shibata, Naka-gun (JP)

(21) Appl. No.: 15/561,203

(22) PCT Filed: Jul. 31, 2015
(86) PCT No.: PCT/JP2015/071886

§ 371 Date: Sep. 25, 2017

(51) Int. Cl. H04N 17/04; H04N 5/445; G06T 7/00; E02F 9/26; B60R 1/00

(52) U.S. Cl. CPC H04N 17/04; H04N 5/445; H04N 5/247; E02F 9/26; B60R 1/00; G06T 7/0002

(57) ABSTRACT

A display system of a working machine, includes: one or a plurality of cameras that acquires a peripheral state of the working machine; a display control unit that generates a temporally changing image and outputs, as a video signal, an image obtained by performing a predetermined process on an image or images captured by the one or the plurality of cameras; a monitor that displays, on a basis of the video signal output from the display control unit, the temporally changing image and the image obtained by performing the predetermined process; and an abnormality determination unit that determines that an abnormality has occurred in the display control unit in a case where the temporally changing image remains unchanged for a predetermined time.

### FIELD

The present invention relates to a display system of a working machine and a display method of a working machine that enable, with a simple configuration, a quick recognition of an abnormality in a predetermined process of a peripheral monitoring control unit (display control unit) including an image processing unit.

### BACKGROUND

In the field of working machines such as excavators, there is a known work machine that is equipped with a plurality of cameras installed at a rear side of its body and a side of the body and displays images captured by the cameras as a single camera image on a monitor in the operator cab of the working machine, so that an operator can visually recognize an obstacle existing at the periphery of the body. Further, some work machines generate a bird's eye image to be displayed on the monitor by combining the images of the cameras after converting the images of the cameras into upper viewpoint images, so that the periphery of the body can be monitored at the same time.

Patent Literature 1 describes a working machine that displays, on an image, an icon that indicates an arrangement position of a camera that has acquired a selected single camera image. With this configuration, it is possible to easily recognize by which camera the single camera image has been acquired.

### CITATION LIST

### Patent Literature

Patent Literature 1: International Publication No. 2013/105597

### SUMMARY

### Technical Problem

Meanwhile, since image processing such as generating a bird's eye image is a work that requires a heavy load, it is generally difficult to perform the process by a monitor control unit that is directed to display machine gauge information items (e.g., engine water temperature and a remaining amount of fuel) on a display unit such as a monitor. The process is therefore performed by an image processing controller (a peripheral monitoring control unit) having a general-purpose image processing accelerator separated from the monitor. In such a case, the bird's eye image generated by the image processing controller is an output as a video signal to the display unit of the monitor and is displayed on the display unit.

Here, in a case where some failure occurs in the image processing controller, the image processing controller may continue to transmit the same bird's eye image to the display unit although scenes captured by cameras are being changed due to a movement of the working machine or the like. In this case, although no appropriate images captured by a plurality of cameras are displayed on the display unit, an operator cannot notice that a failure occurs in the image processing controller, since the bird's eye image is displayed to the operator.

The present invention is made in view of the above, and an object thereof is to provide a display system of a working machine and a display method of a working machine that enable, with a simple configuration, a quick recognition of an abnormality in a predetermined process of a peripheral monitoring control unit (a display control unit) including an image processing unit.

### Solution to Problem

To resolve the above-described problem and attain the object, a display system of a working machine according to the present invention includes: one or a plurality of cameras that acquires a peripheral state of the working machine; a display control unit that generates a temporally changing image and outputs, as a video signal, an image obtained by performing a predetermined process on an image or images captured by the one or the plurality of cameras; a monitor that displays, on a basis of the video signal output from the display control unit, the temporally changing image and the image obtained by performing the predetermined process; and an abnormality determination unit that determines that an abnormality has occurred in the display control unit in a case where the temporally changing image remains unchanged for a predetermined time.

Further, in the display system of a working machine according to the present invention, in the above invention, the display control unit and the abnormality determination unit are provided in respective controllers different from each other

Further, in the display system of a working machine according to the present invention, in the above invention, the image obtained by performing the predetermined process by the display control unit is a single camera image and/or a bird's eye image.

Further, in the display system of a working machine according to the present invention, in the above invention, the abnormality determination unit issues information when the abnormality determination unit determines that the abnormality has occurred in the display control unit.

Further, in the display system of a working machine according to the present invention, in the above invention, the information is to display a message or an icon on the monitor indicating that the abnormality has occurred in the display control unit.

Further, in the display system of a working machine according to the present invention, in the above invention, the temporally changing image generated by the display control unit is provided in an outer frame of a single camera image position icon.

Further, in the display system of a working machine according to the present invention, in the above invention, the temporally changing image generated by the display control unit is provided in a display area of the single camera image or the bird's eye image or in a peripheral area of the display area.

Further, in the display system of a working machine according to the present invention, in the above invention, the temporally changing image generated by the display control unit is provided in any part of a combined video display area generated by the display control unit.

Further, in the display system of a working machine according to the present invention, in the above invention, in a case where there are a plurality of images obtained by performing the predetermined process by the display control unit, the temporally changing image is provided for each of the plurality of images, and the abnormality determination unit determines abnormality in each of the images.

Further, a display method of a working machine, the working machine including: one or a plurality of cameras that acquires a peripheral state of the working machine; and a monitor that displays predetermined information, the method includes: a display control step of generating a temporally changing image and outputting, as a video signal, an image obtained by performing predetermined process on an image or images captured by the one or the plurality of cameras; a step of displaying, on the basis of the video signal output in the display control step, the temporally changing image and the image obtained by performing the predetermined process; and an abnormality determination step of determining that an abnormality has occurred in a case where the temporally changing image remains unchanged for a predetermined time.

According to the present invention, a peripheral monitoring control unit as a display control unit generates a temporally changing image and outputs, as a video signal, images obtained by performing predetermined process on images captured by a plurality of cameras, a display unit displays, on the basis of the video signal output from the peripheral monitoring control unit, the temporally changing image and the images obtained by performing the predetermined process, and a monitor control unit as an abnormality determination unit determines and informs that an abnormality has occurred in the predetermined process of the peripheral monitoring control unit in a case where the temporally changing image remains unchanged for a predetermined time. An operator can therefore quickly recognize, with a simple configuration, the abnormality in the predetermined process of the peripheral monitoring control unit.

### BRIEF DESCRIPTION OF DRAWINGS

FIG. 1 is a perspective view illustrating an entire configuration of an excavator on which a peripheral monitoring device of a working machine according to an embodiment of the present invention is mounted.

FIG. 2 is a view illustrating an internal arrangement of an operator cab.

FIG. 3 is a plan view illustrating an arrangement of cameras.

FIG. 4 is a block diagram illustrating an entire control system of the excavator and a detailed configuration of a peripheral monitoring control unit.

FIG. 5 is a view illustrating a generation process of generating a bird's eye image by a bird's eye image generation unit.

FIG. 6 is a view illustrating an example of a temporally changing image.

FIG. 7 is a view illustrating a state where a standard screen is displayed on a display unit of a monitor.

FIG. 8 is a flowchart illustrating an abnormality handling process of the peripheral monitoring control unit by a monitor control unit.

### DESCRIPTION OF EMBODIMENTS

Hereinbelow, embodiments to carry out the present invention will be described with reference to the accompanying drawings.

[Entire Configuration of Excavator]

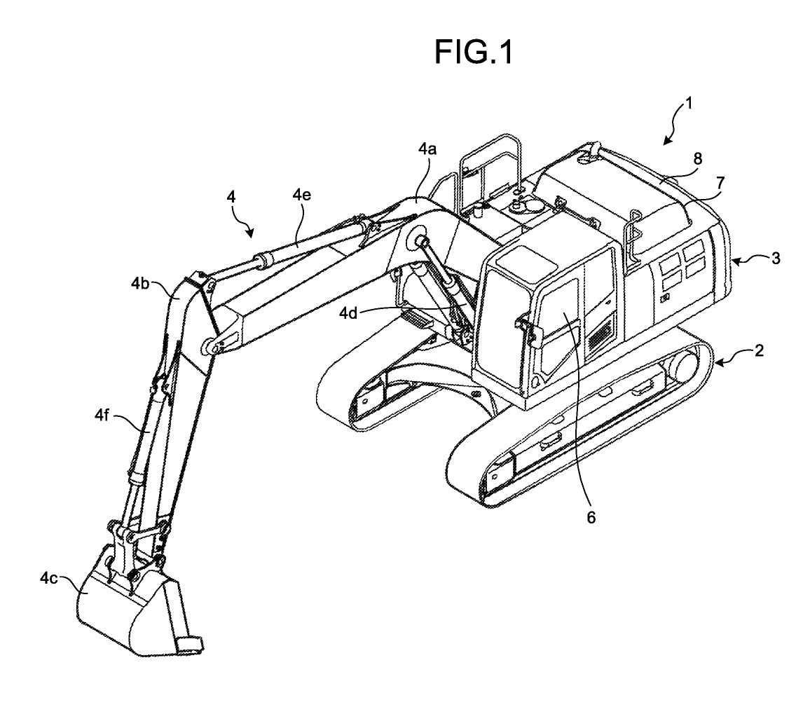

First, FIG. 1 is a perspective view illustrating an entire configuration of an excavator on which a peripheral monitoring device of a working machine according to an embodiment of the present invention is mounted. An excavator 1 is illustrated as an example of the working machine. The excavator 1 includes a self-propelled lower traveling body 2, an upper swing body 3 swingably installed on the lower traveling body 2, and a work machine 4 that operates in a manner freely bend or freely raised and lowered at a center of a front portion of the upper swing body 3.

The work machine 4 includes a boom 4a, an arm 4b, a bucket 4c, a boom cylinder 4d, an arm cylinder 4e, and a bucket cylinder 4f.

An operator cab 6 is provided in a front left portion of the upper swing body 3. A power container 7 is mounted on a rear portion of the upper swing body 3. In the power container 7, an engine, a hydraulic pump, a radiator, an oil cooler and the like are housed. A counterweight 8 is mounted on a rear end portion of the upper swing body 3.

[Operator Cab]

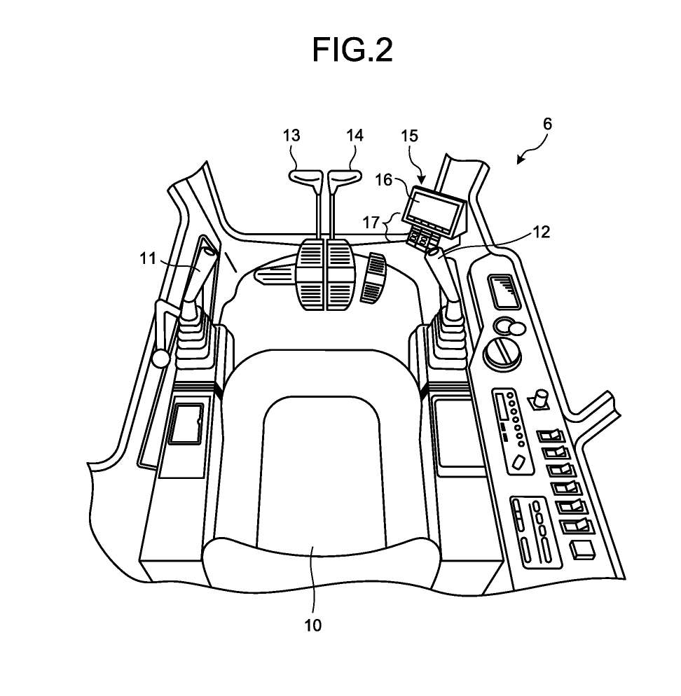

FIG. 2 is a view illustrating an internal arrangement of the operator cab 6. As illustrated in FIG. 2, operation levers 11, 12 are arranged, for example, on the right and left of an operator seat 10 in the operator cab 6. The operation lever 11 corresponds to a swing operation of the upper swing body 3 and an operation of the arm 4b, and the operation lever 12 corresponds to an operation of the boom 4a and an operation of the bucket 4c. Note that the combination of the operations of the operation levers 11, 12 and the work machine to be operated is not limited to that of the present embodiment.

A travel lever 13 and a travel lever 14 can move crawler belts forward and backward on the right and left sides of the lower traveling body 2 in accordance with the operations.

A monitor 15 is disposed in the right front of the operator cab 6. The monitor 15 includes a display unit 16 and an operation unit 17. The display unit 16 refers to a display device such as a liquid crystal display, and can display various information items such as states of the engine, hydraulic pump, and the like, machine information such as engine water temperature, oil temperature, and a remaining amount of fuel, and warning information indicating abnormality of equipment, a menu screen, and a maintenance screen.

Further, the monitor 15 can display an image (a single camera image) captured by a camera, which is described later, and an image (a bird's eye image) generated by converting a plurality of camera images into upper viewpoint images and combining the images.

The operation unit 17 includes function switches having a plurality of functions corresponding to a display content of the display unit 16, and switches that perform various settings including setting of a working mode, a traveling mode, and an air conditioner. Note that the monitor 15 may be a touch panel where the display unit 16 and the operation unit 17 are integrated. Further, the operation unit 17 may be provided separately from the display unit 16, and the operation unit 17 may be provided at another position in the operator cab.

[Configuration of Camera]

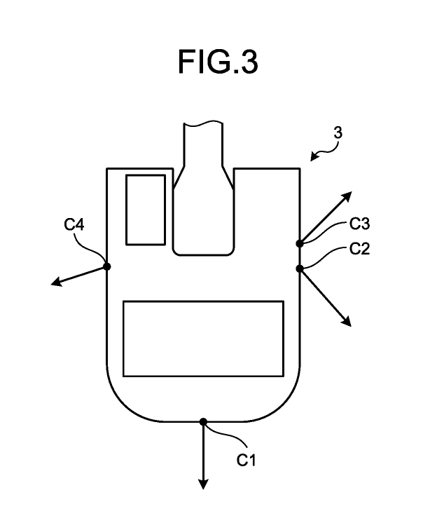

Cameras C1 to C4 are attached to the upper swing body 3. As illustrated in FIG. 3, the camera C1 is attached to a rear side of the upper swing body 3 to capture the rear side of the upper swing body 3. Further, the camera C2 is attached to a right side of the upper swing body 3 to capture a right rear side of the upper swing body 3. In addition, the camera C3 is attached to the right side of the upper swing body 3 to capture a right front side of the upper swing body 3. Moreover, the camera C4 is attached to a left side of the upper swing body 3 to capture the left side of the upper swing body 3. Note that, for example, each of the cameras C1 to C4 has a visual field range of predetermined angles in a horizontal direction and a height direction. Charge-coupled device (CCD) cameras may be used as the cameras. Further, each of the cameras C1 to C4 may have a wide dynamic range function.

[Entire Configuration of Control System]

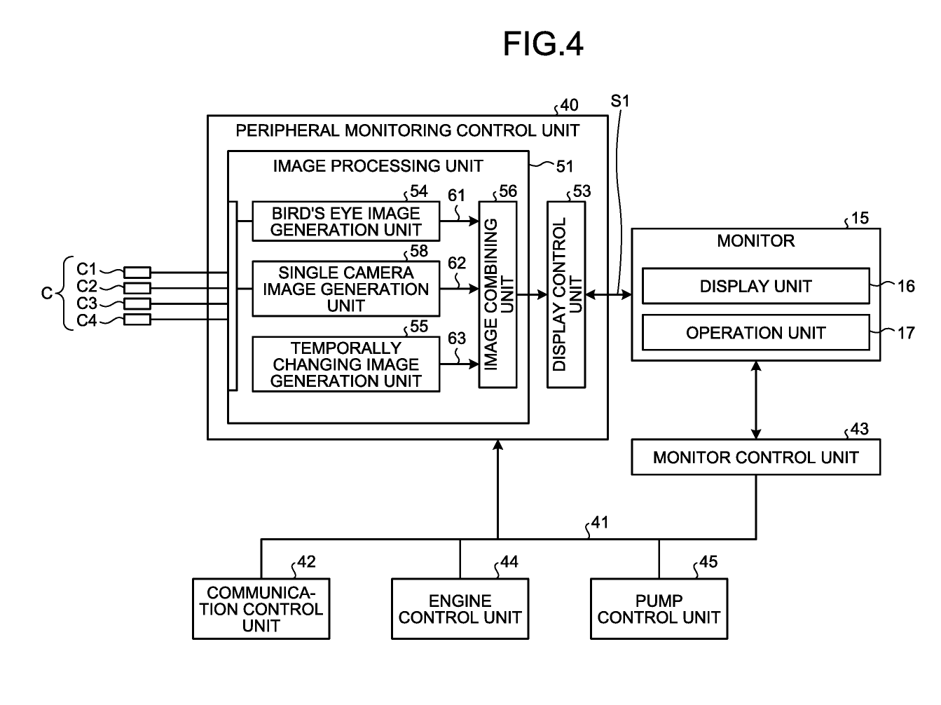

FIG. 4 is a block diagram illustrating a configuration of an entire control system of the excavator 1. As illustrated in FIG. 4, a peripheral monitoring control unit 40 (a display control unit), a communication control unit 42, a monitor control unit 43 (an abnormality determination unit), an engine control unit 44, a pump control unit 45 and the like are connected to a CAN 41, which is one of in-vehicle networks.

The monitor control unit 43 is connected to the monitor 15 to function as a display control unit of the monitor 15. The monitor control unit 43 controls input and output of various information of the working machine such as information transmitted from various sensors via the CAN 41, and information input via the switch provided on the monitor 15. In addition, the monitor 15 can perform control to display the machine information such as the engine water temperature, the oil temperature, and the remaining amount of the fuel, the warning information indicating abnormality of the equipment and the like, the menu screen, and the maintenance screen.

The peripheral monitoring control unit 40 is connected to a camera group C including the plurality of cameras C1 to C4 and the monitor 15, and as will be described later, outputs, to the monitor, an image obtained by combining a single camera image of one of the plurality of cameras and a bird's eye image.

The peripheral monitoring control unit 40 includes an image processing unit 51 and a display control unit 53. Further, the image processing unit 51 includes a bird's eye image generation unit 54, a single camera image generation unit 58, a temporally changing image generation unit 55, and an image combining unit 56.

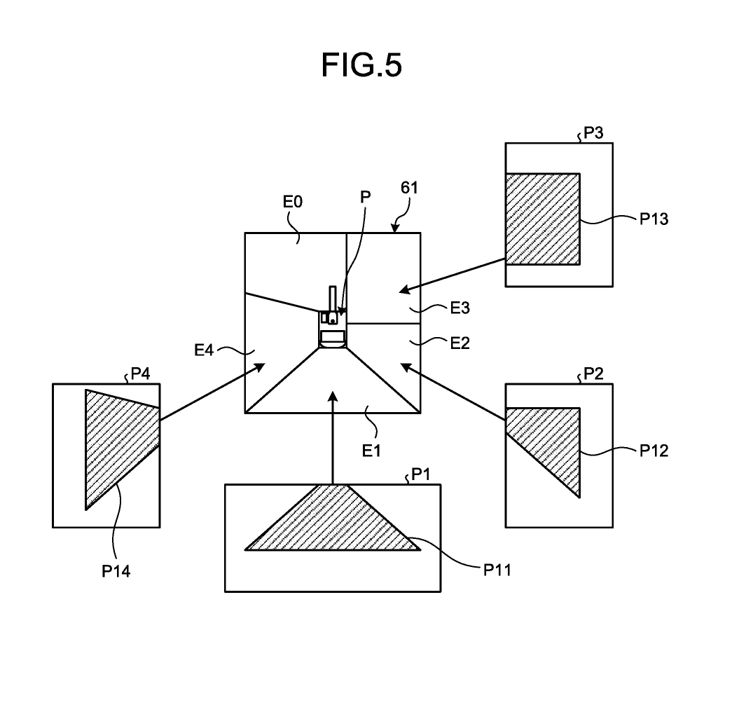

The bird's eye image generation unit 54 generates a bird's eye image 61 on the basis of the images obtained by the cameras C1 to C4. As illustrated in FIG. 5, the bird's eye image generation unit 54 converts images P1 to P4 respectively obtained by the cameras C1 to C4 into upper viewpoint images. That is, the bird's eye image generation unit 54 converts the images into images viewed from a predetermined virtual viewpoint located above the excavator 1.

Specifically, the bird's eye image generation unit 54 performs an image conversion in which the images are projected from the virtual viewpoint above the excavator 1 onto a predetermined virtual projection plane corresponding to a ground level. Thereafter, the bird's eye image generation unit 54 cuts out converted images P11 to P14 corresponding to areas E1 to E4 of a frame displaying the bird's eye image, so that the converted images P11 to P14 are combined within the frame. An image P of the excavator 1 viewed from above is pasted in advance to the bird's eye image 61 generated by the bird's eye image generation unit 54, so that a positional relationship with the excavator becomes clear.

Information of the bird's eye image 61 is input to the image combining unit 56. Note that, since an area E0 can be visually recognized from the operator cab 6, the bird's eye image is not generated. Further, the four cameras C1 to C4 are used in the present embodiment, but the number of cameras may be any number. For example, three cameras C1, C2, C4 may be used. In this case, the camera C2 captures the right side similar to the camera C4.

The single camera image generation unit 58 outputs a single camera image 62 of any one of the images captured by each of the cameras C1 to C4 to the image combining unit 56. Specifically, in a case where an operation to switch the single camera image 62 is performed by the operation unit 17 by the operator, a signal indicating that is transmitted to the single camera image generation unit 58 via the monitor control unit 43 and the CAN 41, and the single camera image generation unit 58 outputs the single camera image 62 of the corresponding camera which received a command to the image combining unit 56.

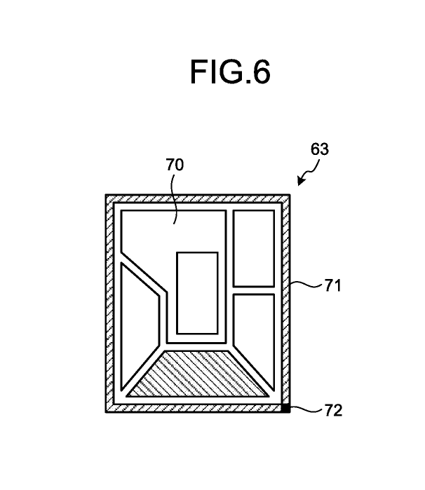

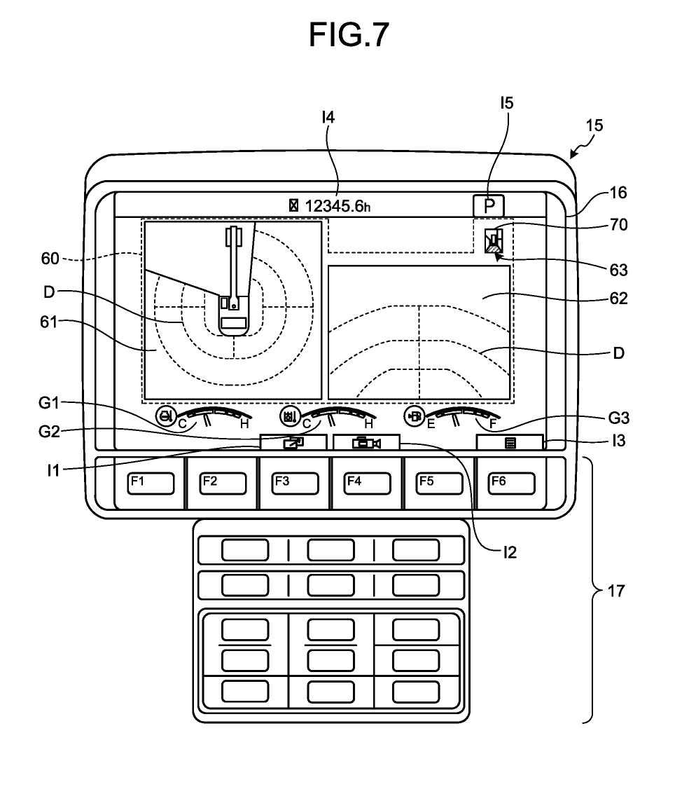

The temporally changing image generation unit 55 generates a temporally changing image 63 that changes with time. For example, a single camera image position icon 70 in the temporally changing image 63 illustrated in FIG. 6 is an icon that indicates a photographing direction (rear side, right rear side, right front side, left rear side) with respect to the excavator of the camera that photographs the single camera image 62 displayed on the display unit 16 of the monitor 15, and by providing, for example, the single camera image position icon 70 in the vicinity of the single camera image 62 of the display unit 16 in FIG. 7, the operator can easily determine the single camera image 62 displayed on the display unit 16 is a single camera image in which direction.

A rectangle in a central portion of the single camera image position icon 70 represents a plan view of the excavator, and an area corresponding to the direction of the single camera image is displayed with colors, an upper side of the single camera image position icon 70 being assumed to be a front side. For example, in cases of FIGS. 6 and 7, it is indicated that a single camera image of a rear side camera that photographs a lower area of the rectangle at the central portion, that is, the rear side of the excavator is displayed.

An outer frame 71 of the single camera image position icon 70 blinks in predetermined colors with a lapse of time. For example, when the icon is turned on, the outer frame 71 portion is displayed in yellow-green color, and when the icon is turned off, the outer frame 71 portion is displayed in black color, that is, yellow-green color and black color are alternately switched over time.

Here, in a case where any failure occurs in the peripheral monitoring control unit 40, there is a possibility that the peripheral monitoring control unit 40 continuously outputs the same image to the monitor. In that case, the outer frame 71 does not change from the state of being displayed in yellow-green color or black color. The operator can therefore recognize that the peripheral monitoring control unit 40 is executing normal image processing by confirming whether the outer frame 71 portion is blinking.

The combination of the single camera image position icon 70 and the outer frame 71 is generated as the temporally changing image 63 by the temporally changing image generation unit 55. Note that a partial area 72 refers to an area provided at a corner portion of the outer frame 71, and similar to the other area of the outer frame 71, color of the partial area 72 alternately switches over time between yellow-green color and black color, for example.

As will be described later, by detecting whether a value of a video signal such as luminance and an RGB value in the partial area 72 has changed or not, it is determined whether the temporally changing image 63 fluctuates with time or not. The temporally changing image 63 generated by the temporally changing image generation unit 55 is input to the image combining unit 56.

The above-described bird's eye image 61, the single camera image 62 captured by each of the cameras C1 to C4, and the temporally changing image 63 are input to the image combining unit 56. The image combining unit 56 generates an image obtained by combining the above-described bird's eye image 61, single camera image 62, and temporally changing image 63 on the basis of a control signal instructed from the monitor control unit 43 via the CAN 41. The image obtained by combining these three images is output to the display unit 16 as a video signal S1 via the display control unit 53.

In a case where the image combining unit 56 does not receive an instruction to output the image obtained by combining the bird's eye image 61, the single camera image 62, and the temporally changing image 63 from the monitor control unit 43 (for example, in a case where the menu screen is selected), the image combining unit 56 does not output the combined image to the monitor.

[Standard Screen of Monitor]

FIG. 7 is a view illustrating a state where an example of a standard screen is displayed on the display unit 16 of the monitor 15. The standard screen refers to an initial screen displayed after a certain period of time has elapsed since a key switch is turned on, and displays various information of the working machine, that is, for example, the machine information such as the engine water temperature, the oil temperature, and the remaining amount of the fuel and the warning information indicating abnormality of the equipment and the like, the menu screen, the maintenance screen, the bird's eye image, and the single camera image.

As illustrated in FIG. 7, the bird's eye image 61 is displayed on the left of the display unit 16, and the single camera image 62 is displayed on the right of the display unit 16. The single camera image 62 in FIG. 7 is an image of the rear side captured by the camera C1 provided at the rear side of the upper swing body 3. In the bird's eye image 61 and the single camera image 62, a reference line(s) D indicating a reference(s) of a distance(s) and a direction(s) from a swing center is displayed. On the upper right of the single camera image 62, the temporally changing image 63 is displayed.

The bird's eye image 61, the single camera image 62, and the temporally changing image 63 are images generated on a side of the peripheral monitoring control unit 40, and an area where these three images are displayed is defined as a combined video display area 60. Note that, in FIG. 7, the bird's eye image 61 is displayed on the left side and the single camera image 62 is displayed on the right side, but the display positions of these images may be reversed.

In a lower portion of the combined video display area 60, from the left-hand side, there are displayed an engine water temperature gauge G1 that indicates temperature of engine cooling water, a working oil temperature gauge G2 that indicates temperature of working oil in a hydraulic circuit, and a fuel level gauge G3 that indicates a level of a remaining amount of fuel. Further, the working oil temperature gauge G2 may not be displayed.

Note that the function switches F1 to F6 refer to the switches for inputting signals corresponding to icons displayed right above each of the switches by the display unit 16. In FIG. 7, on an upper portion of the function switch F3, an icon I1 is displayed that switches the single camera image 62 to full screen display. Further, on an upper portion of the function switch F4, an icon 12 is displayed that switches the camera of the single camera image 62 (for example, switches from the image of the camera C1 to the image of the camera C2). On an upper portion of the function switch F6, an icon I3 is displayed that switches to the menu screen. The menu screen refers to a screen used for checking various settings and status of the working machine.

Note that the icons I1 to I3 corresponding to the function switches may not be displayed, and the corresponding switches may be provided in another operation unit or the like. An icon 14 displays a value of a service meter. Further, an icon 15 displays a setting state of a working mode.

[Abnormality Detection Processing of Peripheral Monitoring Control Unit]

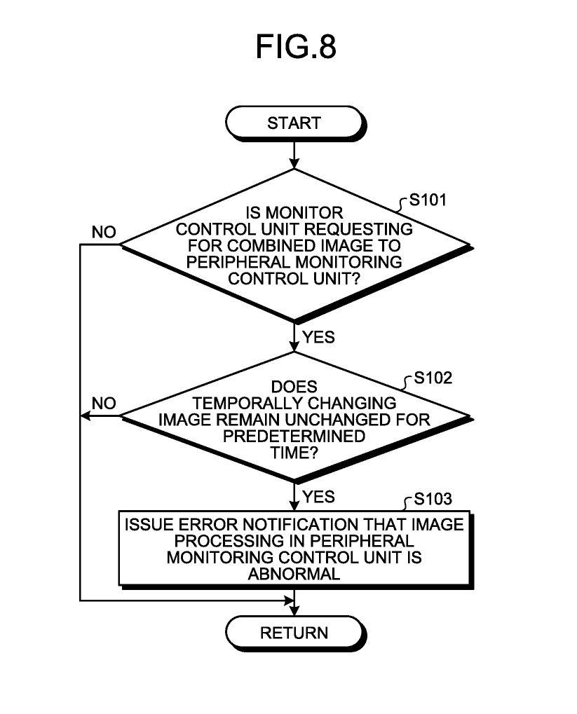

FIG. 8 is a flowchart illustrating an abnormality handling process of the peripheral monitoring control unit 40 by the monitor control unit 43. The monitor control unit 43 functions as an “abnormality determination unit” in the present invention. As illustrated in FIG. 8, the monitor control unit 43 first determines whether the monitor control unit 43 is requesting for the image obtained by combining the bird's eye image 61, the single camera image 62, and the temporally changing image 63 to the peripheral monitoring control unit 40 (Step S101).

In a case where the monitor control unit 43 is requesting for the combined image (step S101, Yes), the monitor control unit 43 determines whether the temporally changing image 63 in the combined image of the combined video display area 60 output from the peripheral monitoring control unit 40 to the monitor 15 remains unchanged for a predetermined time (Step S102). Here, whether the image of the temporally changing image 63 remains unchanged for a predetermined time may be determined based on, for example, a temporal change of the video signal in the partial area 72 of the outer frame 71 in FIG. 6, which is an enlarged view of the temporally changing image 63 in FIG. 7, for example, a temporal change of the luminance, the RGB value and the like. The length of the “predetermined time” may be appropriately set, for example, according to a blinking speed of the outer frame 71 portion.

In a case where the image of the temporally changing image 63 remains unchanged for the predetermined time (step S102, Yes), an error notification indicating that the image processing in the peripheral monitoring control unit 40 is abnormal is issued (step S103) in order to notify the operator or the like in some way that abnormality has occurred. Note that, as an example of the error notification, a message or an icon may be displayed on the display unit 16 of the monitor 15, or the error notification may be displayed by a lamp or the like on a place other than the monitor. Also, the error notification may be a buzzer notification by voice.

On the other hand, in a case where the monitor control unit 43 is not requesting the peripheral monitoring control unit 40 for the combined image (step S101, No), or in a case where the image of the temporally changing image 63 changes in the predetermined time (step S102, No), the step returns to step S101, and the above-described process is repeated.

Note that the reason for providing step S101 is that, in a case where the monitor control unit 43 does not instruct the peripheral monitoring controller 40 to generate the combined image, that is, in a case where the menu screen different from the standard screen in FIG. 7 is displayed, for example, an image that changes over time is not displayed in the area where the temporally changing image 63 is displayed on the standard screen, and the same image is continuously displayed, and as a result, the monitor control unit 43 determines that there is an abnormality even though no abnormality has occurred in the peripheral monitoring control unit 40.

Note that, in the above-described embodiment, the outer frame 71 of the single camera image position icon 70 is set as the temporally changing image 63, and whether there has been abnormality in the image processing of the peripheral monitoring control unit 40 is detected on the basis of presence or absence of the temporal change of the luminance, the RGB value, and other video signals in the partial area 72 of the outer frame 70. However, the present invention is not limited to the above configuration, and the temporally changing image may be generated in any area as long as the area is within the combined video display area 60 generated by the peripheral monitoring control unit 40, such as a partial area in the bird's eye image 61 or the single camera image 62, or periphery of these images. In this case, the temporally changing image to be generated may be of any size as long as it can be visually recognized.

In a case where the outer frame 71 of the temporally changing image 63 according to the present embodiment is blinked, it is preferable that the blink be visually recognized. This is because the operator can recognize that the peripheral monitoring control unit 40 is executing a normal image processing by visually recognizing the blink of the outer frame 71 portion.

Note that the present invention provides an effect that, since the operator can recognize whether an abnormality has occurred in the image processing of the peripheral monitoring control unit 40 without frequently checking whether the outer frame 71 portion is blinking, a workload for checking by the operator can be reduced.

In the above-described embodiment, the bird's eye image 61 and the single camera image 62 are simultaneously displayed on the standard screen, but the present invention is not limited to this, and only the bird's eye image or only the single camera image may be displayed. Alternatively, the bird's eye image 61 and the single camera image 62 may not be displayed on the standard screen, and may be displayed by switching the screen.

Further, “an image obtained by performing a predetermined process on an image or images captured by one or a plurality of cameras” in the present invention may be an image including the bird's eye image, the single camera image, or both of these images, or an image displayed in the combined video display area 60.

In addition, the peripheral monitoring control unit 40 (the display control unit) and the monitor control unit 43 (the abnormality determination unit) may be provided in one controller (device), or may be provided in different controllers (devices).

Furthermore, in the present embodiment, only one temporally changing image 63 is provided, but in a case where a plurality of images is displayed on one screen, a temporally changing image corresponding to each of the images may be prepared so that whether an abnormality has occurred in each image can be detected.

Note that an excavator is used for explanation in the above embodiment. However, the present invention may be applied to a working machine such as a dump truck, a bulldozer, and a wheel loader, as long as they are working machines.

Further, in the above embodiment, the configuration is described in which the monitor 15 is provided in the operator cab 6 of the working machine. But the display unit may be provided in other places, for example, a remote control room for performing remote control of the working machine, or a control room for managing and controlling a plurality of working machines as a whole in a construction site. The monitor 15 may be provided as a mobile terminal (for example, the monitor 15 may be detachable), and the operator may view the bird's eye image displayed on the display unit of the mobile terminal.

Here, in a case where the bird's eye image is displayed on the monitor 15 in the remote control room or the control room, or in a case where the monitor 15 is provided in the mobile terminal, a transmission and/or a reception of information such as the bird's eye image can be performed by providing some communication means in the working machine and each of the operation room, the control room, the mobile terminal and the like.

### REFERENCE SIGNS LIST

1 EXCAVATOR
2 LOWER TRAVELING BODY
3 UPPER SWING BODY
4 WORK MACHINE
4a BOOM
4b ARM
4c BUCKET
4d BOOM CYLINDER
4e ARM CYLINDER
4f BUCKET CYLINDER
6 OPERATOR CAB
7 POWER CONTAINER
8 COUNTERWEIGHT
10 OPERATOR SEAT
11, 12 OPERATION LEVER
13, 14 TRAVEL LEVER
15 MONITOR
16 DISPLAY UNIT
17 OPERATION UNIT
40 PERIPHERAL MONITORING CONTROL UNIT (DISPLAY CONTROL UNIT)
42 COMMUNICATION CONTROL UNIT
43 MONITOR CONTROL UNIT (ABNORMALITY DETERMINATION UNIT)
44 ENGINE CONTROL UNIT
45 PUMP CONTROL UNIT
51 IMAGE PROCESSING UNIT
53 DISPLAY CONTROL UNIT
54 BIRD'S EYE IMAGE GENERATION UNIT
55 TEMPORALLY CHANGING IMAGE GENERATION UNIT
56 IMAGE COMBINING UNIT
58 SINGLE CAMERA IMAGE GENERATION UNIT
60 COMBINED VIDEO DISPLAY AREA
61 BIRD'S EYE IMAGE
62 SINGLE CAMERA IMAGE
63 TEMPORALLY CHANGING IMAGE
70 SINGLE CAMERA IMAGE POSITION ICON
71 OUTER FRAME
72 PARTIAL AREA
C CAMERA GROUP
C1 to C4 CAMERA
D REFERENCE LINE
G1 ENGINE WATER TEMPERATURE GAUGE
G2 WORKING OIL TEMPERATURE GAUGE
G3 FUEL LEVEL GAUGE
I1 to I5 ICON
S1 VIDEO SIGNAL

1. A display system of a working machine, comprising:
one or a plurality of cameras that acquires a peripheral state of the working machine;
a display control unit that generates a temporally changing image and outputs, as a video signal, an image obtained by performing a predetermined process on an image or images captured by the one or the plurality of cameras;
a monitor that displays, on a basis of the video signal output from the display control unit, the temporally changing image and the image obtained by performing the predetermined process; and
an abnormality determination unit that determines that an abnormality has occurred in the display control unit in a case where the temporally changing image remains unchanged for a predetermined time.

2. The display system of a working machine according to claim 1, wherein the display control unit and the abnormality determination unit are provided in respective controllers different from each other.

3. The display system of a working machine according to claim 1, wherein the image obtained by performing the predetermined process by the display control unit is a single camera image and/or a bird's eye image.

4. The display system of a working machine according to claim 1, wherein the abnormality determination unit issues information when the abnormality determination unit determines that the abnormality has occurred in the display control unit.

5. The display system of a working machine according to claim 4, wherein the information is to display a message or an icon on the monitor indicating that the abnormality has occurred in the display control unit.

6. The display system of a working machine according to claim 1, wherein the temporally changing image generated by the display control unit is provided in an outer frame of a single camera image position icon.

7. The display system of a working machine according to any claim 1, wherein the temporally changing image generated by the display control unit is provided in a display area of the single camera image or the bird's eye image or in a peripheral area of the display area.

8. The display system of a working machine according to claim 1, wherein the temporally changing image generated by the display control unit is provided in any part of a combined video display area generated by the display control unit.

9. The display system of a working machine according to claim 1, wherein, in a case where there are a plurality of images obtained by performing the predetermined process by the display control unit, the temporally changing image is provided for each of the plurality of images, and the abnormality determination unit determines abnormality in each of the images.

10. A display method of a working machine, the working machine comprising:
one or a plurality of cameras that acquires a peripheral state of the working machine; and
a monitor that displays predetermined information,
the method comprising:
a display control step of generating a temporally changing image and outputting, as a video signal, an image obtained by performing predetermined process on an image or images captured by the one or the plurality of cameras;
a step of displaying, on the basis of the video signal output in the display control step, the temporally changing image and the image obtained by performing the predetermined process; and
an abnormality determination step of determining that an abnormality has occurred in a case where the temporally changing image remains unchanged for a predetermined time.
